(19) United States
(12) Patent Application Publication
(10) Pub. No.: US 2012/0125206 A1
(43) Pub. Date: May 24, 2012

(54) HEATING DEVICE

(75) Inventor: Shinichi Yamane, Osaka (JP)

(73) Assignee: PANASONIC CORPORATION, Kadoma-shi, Osaka (JP)

(21) Appl. No.: 13/387,998

(22) PCT Filed: Sep. 13, 2010
(86) PCT No.: PCT/JP2010/005569

§ 371 Date: Jan. 30, 2012

(30) Foreign Application Priority Data
Sep. 17, 2009 (JP) 2009-215352

(51) Int. Cl. F24C 15/20; B01D 46/42; F24C 15/00

(52) U.S. Cl. 99/337; 126/21 A; 96/419; 96/420

(57) ABSTRACT

A heating device including a heat chamber to accommodate an object to be heated, a heater, an exhaust port, an exhaust fan to eject air from inside the heat chamber through an exhaust port, and a filter to eliminate oily smoke from an exhaust gas, the heating device further including a first temperature detector to detect a temperature inside the heat chamber, a second temperature detector to detect the temperature of the air ejected through the exhaust port, and a controller to judge whether the filter is clogged or not based on a rotation number of the exhaust fan, and a difference between a temperature Tₒ in the heat chamber and a temperature Tₑₓ of the air ejected through the exhaust port.

### TECHNICAL FIELD

The present invention pertains to a heating device.

### BACKGROUND ART

In recent years, various kinds of foodstuff are cooked by a heating device and menu is increasing in number with it. As a variety of cooking is repeatedly made, inside a cooking chamber of the heating device becomes contaminated. Usually, a user removes contamination based on judging from visual inspection. If the user is negligent of cleaning, food residue may gather in the chamber or the chamber may be overheated, causing a cooking and safety problem. In order to ensure a tasty cooking and secure safety of the heating device, a device having a cleaning notification function is required.

With a conventional heating device, a time period required for cooking is accumulated, and when the accumulated time period reaches a prescribed time schedule for cleaning, the device notifies the user, urging cleaning. (Refer to Patent Literature 1, for instance)

With the conventional heating device, however, since such notification is made based on the accumulated time period, the function may fail to work properly in a timely manner even though the heat chamber is already contaminated, or it may wrongly work too early even though the chamber is not yet contaminated, leaving a problem.

### PTL1: Japanese Patent Unexamined Publication No. 2002-298211

### SUMMARY OF THE INVENTION

The heating device of the invention includes a heat chamber to accommodate an object to be heated, a heater to heat up the heat chamber, an exhaust port formed with the heat chamber, an exhaust fan to eject air from inside the heat chamber through the exhaust port, a filter disposed at the exhaust port to eliminate oily smoke from exhaust gas which is ejected from the heat chamber. The heating device of the invention further includes a first temperature detector to detect a temperature Tₒ in the heat chamber, a second temperature detector to detect a temperature Tₑₓ of the air ejected through the exhaust port, and a controller to judge whether the filter is clogged or not based on a rotation number Rₑₓ of the exhaust fan and a difference between the temperature To and the temperature Tₑₓ. With this configuration, even when a user is negligent of periodic cleaning, the heating device of the invention urges a cleaning corresponding to a degree of contamination of the filter and only when contamination which requires cleaning occurs.

### BRIEF DESCRIPTION OF THE DRAWINGS

FIG. 1 is a cross section view of a heating device according to a first exemplary embodiment of the present invention.

FIG. 2 is a drawing showing an exhaust path of exhaust gas which is generated in a heat chamber of the heating device according to the first exemplary embodiment of the present invention.

FIG. 3 is a flow chart explaining a basic operation of the heating device according to the first exemplary embodiment of the present invention.

FIG. 4 is a flow chart explaining controlling process of an upper heater of the heating device according to the first exemplary embodiment of the present invention.

FIG. 5 is a flow chart explaining controlling process of a lower heater of the heating device according to the first exemplary embodiment of the present invention.

FIG. 6 is a graphical chart explaining a relation between a change in temperature in the heat chamber and a rotation number of an exhaust fan of the heating device according to the first exemplary embodiment of the present invention.

FIG. 7 is a flow chart showing an operation to judge a clogged filter of the heating device according to the first exemplary embodiment of the present invention.

FIG. 8 is a phase diagram showing a range of ΔT against a rotation number of the exhaust fan of the heating device according to the first exemplary embodiment of the present invention.

FIG. 9 is a phase diagram showing a range of ΔT against a rotation number of the exhaust fan and a temperature of a heater of the heating device according to a second exemplary embodiment of the present invention.

### DETAILED DESCRIPTION OF THE PREFERRED EMBODIMENTS

### First Exemplary Embodiment

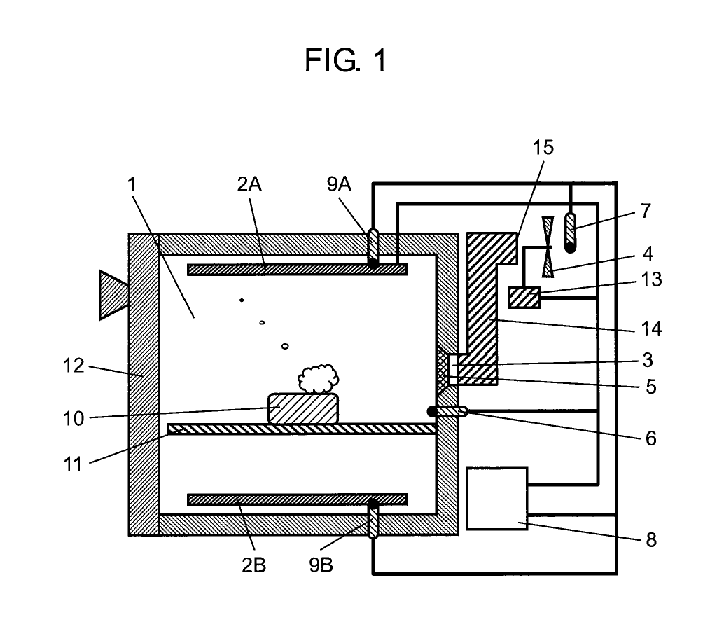

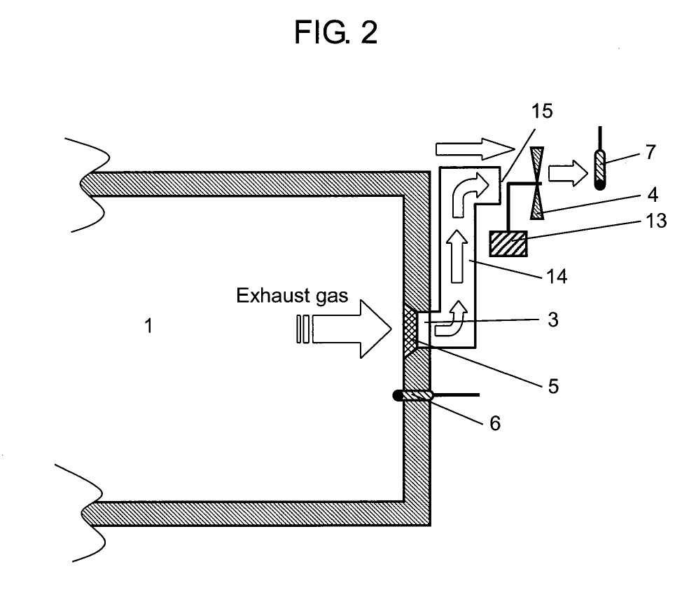

FIG. 1 is a cross section view of a heating device according to a first exemplary embodiment of the present invention. FIG. 2 is a drawing showing an exhaust path of exhaust gas which is generated in a heat chamber of the heating device according to the exemplary embodiment of the present invention. For easy understanding, the exhaust gas path is shown by the expanded view in FIG. 2.

As shown in FIG. 1, the heating device of the present invention includes heat chamber 1, a heater composed of upper heater 2A and lower heater 2B, exhaust port 3, exhaust fan 4, filter 5, first temperature detector 6, second temperature detector 7, third temperature detector 9A and 9B, and controller 8. Upper heater 2A is placed on an upper inside face of heat chamber 1 and lower heater 2B is placed on a lower inside face thereof for heating heat chamber 1. Upper heater 2A has third temperature detector 9A and lower heater 9B has third temperature detector 9B.

The heating device of this present invention also includes heat tray 11 placed inside heat chamber 1. Heat tray 11 puts object to be heated 10 on it, food and other stuff. Object to be heated 10 is accommodated in heat chamber 1 and is put in and out by opening and closing door 12 at a front side of heat chamber 1.

Heat chamber 1 has filter 5 at a rear side of the chamber and first temperature detector 6 at a lower rear side of the chamber to detect temperature Tₒ inside heat chamber 1. Filter 5 is attached to communicate to one end of air duct 14 thorough exhaust ports 3. Another end of air duct 14 constitutes outlet 15, an opening of air duct 14. Near outlet 15, exhaust fan 4 is attached which is driven by motor 13. At a rear side of exhaust fan 4 (facing heat chamber 1), second temperature detector 7 is attached. In this exemplary embodiment, a portion of exhaust path such as filter 5 and first temperature detector 6 is disposed at a rear side of heat chamber 1, but it may be disposed at a side part of heat chamber 1, allowing a freedom of design of the device.

As is shown in FIG. 2, exhaust gas from inside heat chamber 1 passes through filter 5 where oily smoke is removed by filter 5. The exhaust gas then passes through air duct 14 and is expelled by air exhaust fan 14 from air outlet 15 out of heat chamber 1. When the exhaust gas is discharged from air outlet 15, second temperature detector 7 detects a temperature of mixed air, the mixed air being the exhaust gas and outside air mixed by turning exhaust fan 4. In the present invention, exhaust gas is a general term of gas including volatile gas and water vapor generated from heated foodstuff.

Heat chamber 1 has controller 8 at an outside of heat chamber 1. Controller 8 judges whether filter 5 is clogged or not, controls rotation of exhaust fan 4, and controls an amount of output from upper heater 2A and lower heater 2B. The device of this present invention is thus configured.

A controlling method of the heating device is explained next.

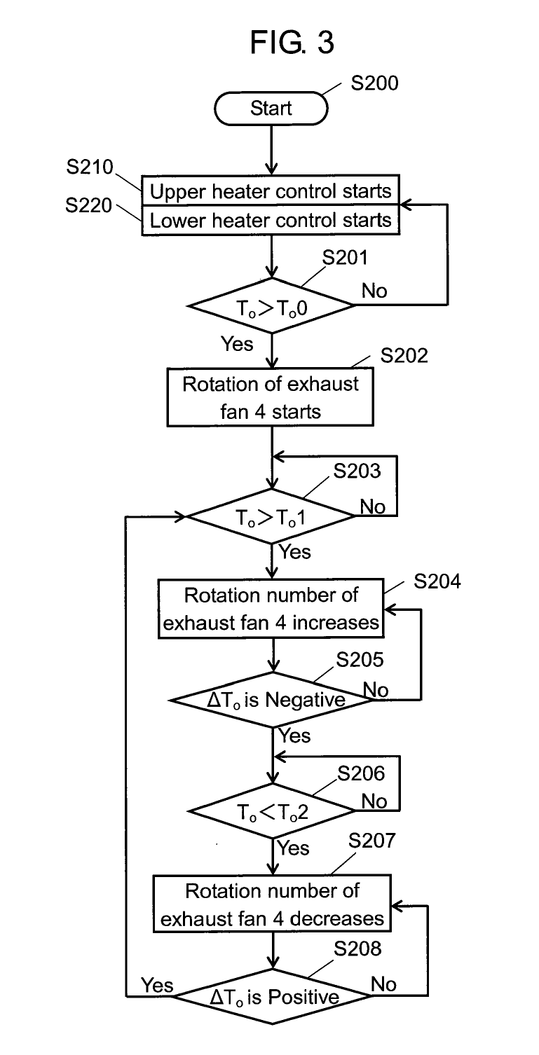

FIG. 3 is a flow chart which shows a basic operation of the heating device of the first exemplary embodiment of the present invention. Constituent members in FIG. 1 are referred to when explaining the basic of operation.

As shown in FIG. 3, when the heating device of the embodiment is turned on, controller 8 starts heating heat chamber 1 (S200). As soon as the chamber is heated, controller 8 starts controlling upper heater 2A and lower heater 2B (S210, S220).

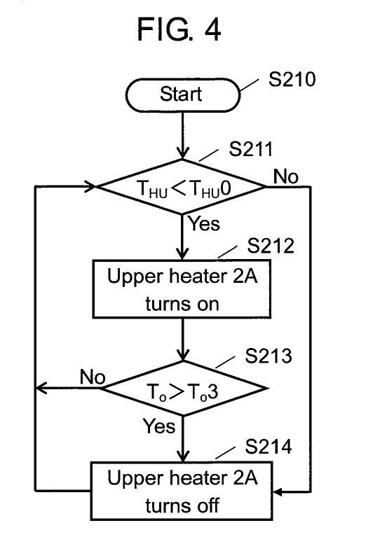

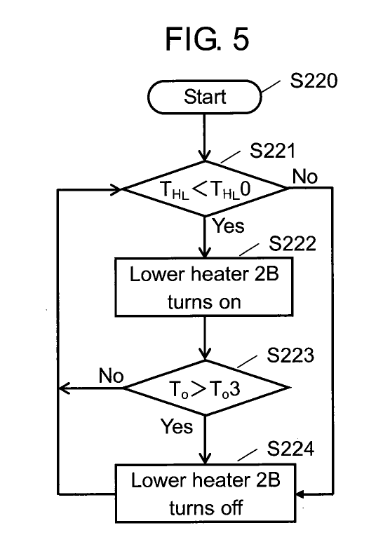

A method of control is specifically explained with FIGS. 4 and 5.

FIG. 4 is a flow chart explaining controlling process of the upper heater of the heating device of the first exemplary embodiment of the present invention.

As shown in FIG. 4, controller 8 first controls upper heater 2A (S210), and then controller 8 compares a temperature T_{HU} of upper heater 2A with a set temperature T_{HU}0 of upper heater 2A. When temperature T_{HU} of upper heater 2A is below the set temperature T_{HU}0 (Yes of S211), the controller turns on upper heater 2A (S212).

If the temperature T_{HU} of upper heater 2A is higher than the set temperature T_{HU}0 (No of S211), the controller turns off upper heater 2A (S214). After upper heater 2A is turned on (S212) and when the temperature Tₒ of heat chamber 1 is higher than the threshold temperature Tₒ3 (350° C., for instance) in heat chamber 1 (Yes of S213), the controller also turns off upper heater 2A (S214). If the temperature Tₒ of heat chamber 1 is lower than the threshold temperature Tₒ3 of heat chamber 1 (No of S211), controller 8 returns to the step for comparing the temperature T_{HU} of upper heater 2A with the set temperature T_{HU}0 of upper heater 2A (S211).

FIG. 5 shows a control process of lower heater of the heating device according to first exemplary embodiment of the present invention.

FIG. 5 shows that controller 8 controls lower heater 2B (S220) first. Controller 8 then compares a temperature T_{HL} of lower heater 2B with a set temperature T_{HL}0 of lower heater 2B. If the temperature T_{HL} of lower heater 2B is below the set temperature T_{HLO}, the controller turns on lower heater 2B (S222).

If the temperature T_{HL} of lower heater 2B is higher than the set temperature T_{HL}0 (Yes of S221), the controller turns off lower heater 2B (S224). After turning on lower heater 2B (S222), if the temperature Tₒ of heat chamber 1 is higher than a threshold temperature Tₒ3 (350° C., for instance) of heat chamber 1 (Yes of S223), the controller also turns off lower heater 2B (S224). If the temperature Tₒ of heat chamber 1 is lower than the threshold temperature Tₒ3 of heat chamber 1 (No of S223), controller 8 returns to the step for comparing the temperature T_{HL} of lower heater 2B with the set temperature T_{HL}0 of lower heater 2B (S221).

With above arrangements, inside heat chamber 1 is always maintained to a certain constant temperature, so that even when cooking is repeated, a stable cooking is achieved each time.

When the constant temperature is achieved in heat chamber 1, controller 8 compares the temperature Tₒ of heat chamber 1 with a predetermined temperature Tₒ0 as a set temperature (100° C., for instance), as is shown in FIG. 3 (S201). If the temperature Tₒ in heat chamber 1 is not reached to the predetermined temperature Tₒ0 (No of S201), controller 8 stands by until the temperature goes up to the predetermined temperature Tₒ0. If the temperature Tₒ in heat chamber 1 exceeds the predetermined temperature Tₒ0 (Yes of S201), the controller runs exhaust fan 4 (S202).

Then, controller 8 compares the temperature Tₒ in heat chamber 1 with the predetermined temperature T₀1 (280° C., for instance) which is a temperature to start heating a food (S203). If the temperature Tₒ in heat chamber 1 is not reached to the predetermined temperature Tₒ1 (No of S203), controller 8 keeps turning exhaust fan 4 and stands by until the temperature goes up to the predetermined temperature Tₒ1. If the temperature Tₒ in heat chamber 1 is higher than the predetermined temperature Tₒ1 (Yes of S203), the controller increases a rotation number of exhaust fan 4 to the lower temperature To of heat chamber 1 (S204).

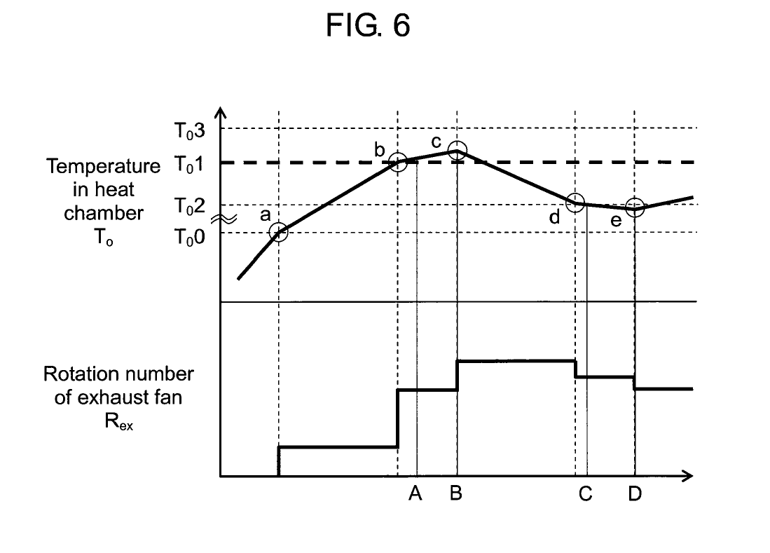

After the temperature Tₒ in heat chamber 1 reaches to the predetermined temperature Tₒ1, the controller measures a temperature change (from TₒA to TₒB) in an optionally determined time frame (from A to B, for instance, details will be described later with FIG. 6) (S205). If the temperature change ΔTₒ (TₒB−TₒA, for instance) is a negative value (Yes of S205), controller 8 maintains the rotation number of exhaust fan 4. If the temperature change ΔTₒ (TₒB−TₒA, for instance) is a positive value (No of S205), controller 8 increases the rotation number of exhaust fan 4 and stands by until the temperature change ΔTₒ becomes a negative value.

Next, the controller compares temperature Tₒ of heat chamber 1 with a predetermined temperature Tₒ2 as a set temperature (250° C., for instance) (S206). If the temperature Tₒ in heat chamber 1 is lower than the predetermined temperature Tₒ2 (Yes of S206), controller 8 decreases the rotation number of exhaust fan 4 (S207). If the temperature To in heat chamber 1 is higher than the predetermined temperature Tₒ2 (No of S206), controller 8 maintains the rotation number of exhaust fan 4 and stands by until the temperature goes down to the predetermined temperature To2.

After the temperature Tₒ in heat chamber 1 is decreased to the predetermined temperature Tₒ2, a temperature change ΔTₒ (from TₒC to TₒD, for instance) in an optionally determined time frame is measured (C to D, for instance, details will be described later by using FIG. 6). If the temperature change ΔTₒ (TₒD−TₒC) is a positive value (Yes of S208), controller 8 returns to the step of comparing the temperature Tₒ of heat chamber 1 with the predetermined temperature Tₒ1 (280° C., for instance) (S203), meanwhile maintains the rotation number of exhaust fan 4 till the temperature Tₒ of heat chamber 1 goes down to the predetermined temperature Tₒ1. If the temperature change ΔTₒ (TₒD−TₒC) is a negative value (No of S208), controller 8 reduces the rotation number of exhaust fan 4 and stands by until the temperature change ΔTₒ comes back to a positive value.

With such arrangement, the temperature Tₒ in heat chamber 1 is maintained at a constant value within the predetermined set temperature range from Tₒ1 to Tₒ2.

In this exemplary embodiment, when the temperature Tₒ of heat chamber 1 exceeds the predetermined temperature Tₒ1, the temperature Tₒ in heat chamber 1 is lowered to the predetermined temperature Tₒ2 (250° C., for instance). However, the predetermined temperature Tₒ2 may not be necessarily set up (without S206). For an example, when the temperature change ΔTₒ is a negative value even though the temperature Tₒ of heat chamber 1 is below the predetermined temperature Tₒ1, the rotation number of exhaust fan 4 may be decreased and stands by until the temperature in heat chamber 1 exceeds the predetermined temperature Tₒ1. On the other hand, when the temperature change ΔTₒ is a positive value even though the temperature Tₒ in heat chamber 1 is above the predetermined temperature Tₒ1, the rotation number of exhaust fan 4 may be increased and stands by until the temperature in heat chamber 1 goes down below the prescribed temperature Tₒ1. With this configuration, the temperature Tₒ in heat chamber 1 is also maintained in a constant value around the predetermined temperature range Tₒ1.

The rotation number of exhaust fan 4 is controlled by variably changing input power to the motor or variably changing a number of pulses applied to the motor.

Following, an operation of the device is specifically explained by using FIG. 6.

FIG. 6 is a graphical chart explaining a relation between a change in temperature in heat chamber 1 and a rotation number of exhaust fan 4 of the heating device of the first exemplary embodiment of the present invention.

As shown in FIG. 6, when controller 8 first turns on upper heater 2A and lower heater 2B, the temperature Tₒ in heat chamber 1 starts rising. When the temperature in heat chamber 1 reaches a turn-on temperature of exhaust fan 4 as the predetermined temperature Tₒ0 set, exhaust fan 4 starts turning (point a in FIG. 6).

When the temperature Tₒ of heat chamber 1 reaches the predetermined temperature Tₒ1 as a temperature to start heating foodstuff, the controller increases rotation number Rₑₓ of exhaust fan 4 for suppressing a rise of the temperature in heat chamber 1 (point b in FIG. 6).

After temperature Tₒ passes point b in FIG. 6, if a temperature change ΔTₒ (TₒB−TₒA, for instance) is a positive value, it means the temperature is still rising above target temperature Tₒ1 of heat chamber 1, so the controller further increases rotation number Rₑₓ of exhaust fan 4 to decrease the temperature Tₒ of heat chamber 1 (point c in FIG. 6).

When the temperature Tₒ of heat chamber 1 comes down below Tₒ2, the controller decreases rotation number Rₑₓ of exhaust fan 4 and stands by until the temperature Tₒ of heat chamber 1 goes up (point d in FIG. 6).

After temperature Tₒ passes point d of FIG. 6, if the temperature change ΔTₒ (TₒD−TₒC, for instance) is a negative value, it means the temperature Tₒ of heat chamber 1 is lower than Tₒ2 (Tₒ2<Tₒ1), so the controller further decreases rotation number Rₑₓ of exhaust fan 4 and stands by until the temperature Tₒ of heat chamber 1 rises (point e in FIG. 6).

With these arrangements, the temperature Tₒ in heat chamber 1 is always maintained in a constant value within the predetermined set temperature range from Tₒ1 to Tₒ2. Temperature rise is thus controlled and overshoot of temperature control is avoided. In general use of the heating device, however, when temperature in heat chamber 1 is increased above a certain value, exhaust gas may be generated from food or residual substance in heat chamber 1. As explained, exhaust fan 4 rotates and ejects exhaust gas after filter 5 eliminates the oily smoke contained in the exhaust gas, preventing exhaust gas to be ejected from heat chamber 1 in use. Nevertheless, if filter 5 clogs during its use, temperature control inside heat chamber 1 may not work right resulting in malfunction. Following, an appropriate controlling method of the heating device of the present invention which may have a clogged filter is explained.

First, a relation between temperature difference ΔT and clogged filter 5 is explained, the temperature difference ΔT being between the temperature Tₒ of heat chamber 1 and an exhaust gas temperature Tₑₓ. Ordinarily, when the rotation number Rₑₓ of exhaust fan 4 is higher, an amount of ejected exhaust gas from heat chamber 1 is higher, therefore temperature of exhaust gas Tₑₓ detected by second temperature detector 7 is higher, making the temperature difference ΔT smaller. However, if the amount of the exhaust gas ejected from heat chamber 1 is decreased due to clogged filter 5, the temperature difference ΔT is not much reduced even if the rotation number Rₑₓ of exhaust fan 4 becomes higher. By utilizing this relation, the heating device of the exemplary embodiment judges whether the filter is clogged or not.

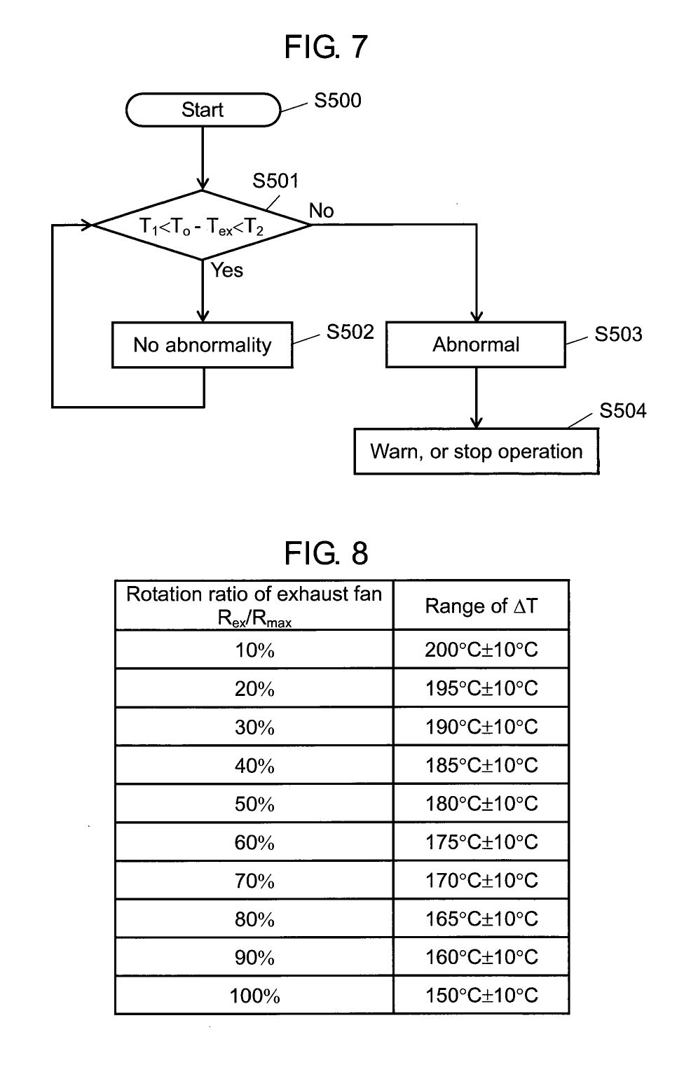

FIG. 7 is a flow chart showing an operation to judge a clogged filter of the heating device according to the first exemplary embodiment. FIG. 8 is a phase diagram showing a range of ΔT against a rotation number of the exhaust fan of the heating device.

As shown in FIG. 7, after turning exhaust fan 4 (S202 in FIG. 3, point a in FIG. 6), controller 8 first judges whether filter 5 is clogged or not by utilizing above mentioned relation (S500). Then, controller 8 calculates a temperature difference ΔT (Tₒ−Tₑₓ) between the temperature Tₒ of heat chamber 1 detected by first temperature detector 6 and the exhaust gas temperature Tₑₓ detected by second temperature detector 7. Next, controller 8 compares calculated the temperature difference ΔT with an already established range of the temperature difference ΔT against the rotation number Rₑₓ of exhaust fan 4 (S501). The comparison is made using data shown in FIG. 8. In FIG. 8, the rotation number Rₑₓ of the exhaust fan is represented by a rotation ratio Rₑₓ/Rₘₐₓ. The rotation number Rₘₐₓ of the exhaust fan is 800 rpm for instance, a 10% of the rotation ratio Rₑₓ/Rₘₐₓ then means a rotation number of 80 rpm. As long as the temperature difference ΔT is within the range in FIG. 8, controller 8 judges that no abnormality exists (S502). If the calculated temperature difference ΔT is not within the range of the temperature difference ΔT against the rotation number Rₑₓ in FIG. 8, the controller judges there is abnormality in filter 5 (S503) and stops operation, having an alarm warn on display or with sound (S504).

More specifically, as shown in FIG. 8, when the rotation ratio Rₑₓ/Rₘₐₓ of the exhaust fan is 10% and the calculated temperature difference ΔT is within the specified range of 190° C.(T₁)<ΔT<210° C.(T₂), controller 8 judges that there is no abnormality. If the calculated temperature difference ΔT is outside the range of 190° C.(T₁)<ΔT<210° C.(T₂), controller 8 judges there is abnormality and suspends supply of power to upper heater 2A and lower heater 2B, or have the alarm give out warning.

As explained, in this exemplary embodiment, a range of temperature difference between the temperature Tₒ of heat chamber 1 and the exhaust gas temperature Tₑₓ, against the rotation number Rₑₓ of the exhaust fan is established beforehand. The device has a controller judging abnormality namely filter 5 is clogged when the temperature difference deviates from the established range of the temperature difference. When filter 5 disposed at exhaust port 3 is clogged, an amount of ejection gas is reduced, lowering exhaust gas temperature Tₑₓ and making the difference between the exhaust gas temperature Tₑₓ and the temperature Tₒ of heat chamber 1 is large, therefore the device judging there is an abnormality

As described, cleaning action is urged corresponding to clogged status of the filter, and the warning is made only when contamination which needs cleaning occurs. Hence, the heating device timely informs a user a contamination of heat chamber 1, realizing a tasteful cooking of foods and assuring safety of operation.

In this exemplary embodiment, the calculated temperature difference ΔT is compared with the range of the temperature difference ΔT against the rotation number Rₑₓ of exhaust fan 4. But, the calculated temperature difference ΔT may be compared with a range of the temperature difference ΔT against an amount of electric power supplied to motor 13.

In this embodiment, the rotation number of exhaust fan 4 is reduced when the temperature of heat chamber 1 goes down below Tₒ2, but exhaust fan 4 may stop rotation instead. If the temperature Tₒ inside heat chamber 1 does not go up to the predetermined temperature Tₒ1 even after exhaust fan 4 stops rotation, this situation may be additionally displayed.

### Second Exemplary Embodiment

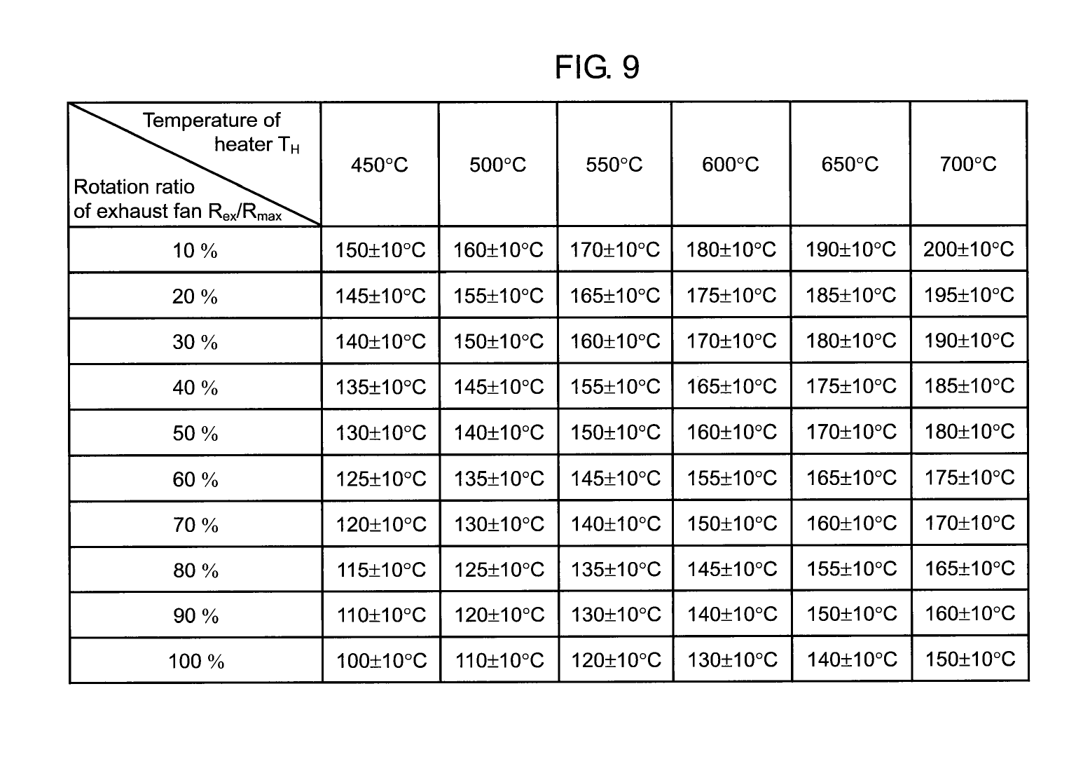

FIG. 9 is a phase diagram showing a range of ΔT, against a rotation number Rₑₓ of the exhaust fan and a temperature T_{H} of the heater of the heating device according to a second exemplary embodiment of the present invention. In this exemplary embodiment, judgment of the clogged filter is made based on data as shown in FIG. 9A, which is a different point from the first exemplary embodiment.

The heating device of the exemplary embodiment compares a calculated temperature difference ΔT, with the range of a temperature difference ΔT against a rotation number Rₑₓ of exhaust fan 4 and a temperature T_{H} of the heater shown in FIG. 9 for judging whether the filter is clogged or not. An operational process of judging the clogged filter is identical to already described one so the explanation is omitted here. With this arrangement, judgment of clogged filter 5 is stably made even when outside temperature is low such as in winter time where exhaust gas temperature Tₑₓ easily goes down.

The values listed in FIGS. 8 and 9 are just some examples. The values change as the heating device changes in size and others.

In this exemplary embodiment, the temperature values of the heater shown in FIG. 9 are average temperatures between upper heater 2A and lower heater 2B. But, the values are not restricted to the average, and the values of only either one of the heaters may be employed.

In each of described embodiment, the heating device of the present invention may include just either one of upper heater 2A and lower heater 2B, or may include a plurality of heaters each heater having its own temperature detector.

Further, in each of above embodiment, the heating device has outlet 15 of air duct 14 at an upper rear side of the heating device, but the heating device may have outlet 15 at a lower rear side thereof.

### INDUSTRIAL APPLICABILITY

The heating device of the present invention is usable for a multifunctional electronic oven, an electronic oven and a variety of ovens for business use having multiple cooking duties, each expected to be used stably for a long period of time.

### REFERENCE MARKS IN THE DRAWINGS

1 heat chamber
2A upper heater (heater)
2B lower heater (heater)
3 exhaust port
4 exhaust fan
5 filter
6 first temperature detector
7 second temperature detector
8 controller
9A, 9B third temperature detector
10 object to be heated
11 heat tray
12 door
13 motor
14 air duct
15 outlet

1. A heating device comprising:
a heat chamber to accommodate an object to be heated;
a heater to heat up the heat chamber;
an exhaust port formed with the heat chamber;
an exhaust fan to eject air from inside the heat chamber through the exhaust port;
a filter disposed at the exhaust port;
a first temperature detector to detect a temperature in the heat chamber;
a second temperature detector to detect a temperature of the air ejected from the exhaust port; and
a controller to judge whether the filter is clogged or not based on a rotation number of the exhaust fan and a difference between the temperature of the air inside the heat chamber and the temperature of air which the second temperature detector detected.

2. The heating device according to claim 1 comprising:
the heat chamber to accommodate the object to be heated;
the heater to heat up the heat chamber;
the exhaust port formed with the heat chamber;
the exhaust fan to eject the air from inside the heat chamber through the exhaust port;
the filter disposed at the exhaust port;
the first temperature detector to detect the temperature in the heat chamber; and
the second temperature detector to detect the temperature of the air ejected from the exhaust port,
further including a third temperature detector to detect a temperature of the heater,
wherein the controller judges whether the filter is clogged or not based on a rotation number of the exhaust fan, a difference between the temperature of the air inside the heat chamber and the temperature of the air which the second temperature detector detected, and the temperature of the heater which the third temperature detector detected.

3. The heating device according to claim 1,
wherein the controller further includes an alarm.

4. The heating device according to claim 1,
wherein the controller controls the rotation number of the exhaust fan and an output of the heater.

5. The heating device according to claim 4,
wherein the controller controls the temperature in the heat chamber by at least;
increasing the rotation number of the exhaust fan, when the temperature in the heat chamber reaches a predetermined temperature;
decreasing the rotation number of the exhaust fan or stops the rotation of the exhaust fan, when the temperature comes down to another predetermined temperature; and
increasing the rotation number of the exhaust fan, when the temperature is not come down to the another predetermined temperature.

6. The heating device according to claim 2,
wherein the controller further includes an alarm.

7. The heating device according to claim 2,
wherein the controller controls the rotation number of the exhaust fan and an output of the heater.

8. The heating device according to claim 7,
wherein the controller controls the temperature in the heat chamber by at least;
increasing the rotation number of the exhaust fan, when the temperature in the heat chamber reaches a predetermined temperature;
decreasing the rotation number of the exhaust fan or stops the rotation of the exhaust fan, when the temperature comes down to another predetermined temperature; and
increasing the rotation number of the exhaust fan, when the temperature is not come down to the another predetermined temperature.
